(19) United States
(12) Patent Application Publication
(10) Pub. No.: US 2009/0209681 A1
(43) Pub. Date: Aug. 20, 2009

(54) UREA-FORMALDEHYDE RESIN REINFORCED GYPSUM COMPOSITES AND BUILDING MATERIALS MADE THEREFROM

(76) Inventors: Leonard J. Adzima, Pickerington, OH (US); Paul R. Krumlauf, Thornville, OH (US); Annabeth Law, Columbus, OH (US); Scott W. Schweiger, Newark, OH (US); Ralph D. McGrath, Granville, OH (US)

Correspondence Address: OWENS CORNING, 2790 COLUMBUS ROAD, GRANVILLE, OH, 43023, US

(21) Appl. No.: 12/032,882

(22) Filed: Feb. 18, 2008

(51) Int. Cl. C04B 26/12; B01F 13/00

(52) U.S. Cl. 524/2; 366/8

(57) ABSTRACT

A composite material containing substantially homogeneous matrix of a gypsum material and a urea-formaldehyde material where wet-used chopped strand fibers are filamentized within the substantially homogeneous matrix.

### TECHNICAL FIELD AND INDUSTRIAL APPLICABILITY OF THE INVENTION

The present invention relates generally to fiberglass-reinforced products, and more particularly, to a urea-formaldehyde gypsum composite building material.

### BACKGROUND OF THE INVENTION

Interior and exterior construction boards, panels and surfaces with cores of plaster, cement, or hybrid materials, such as cement boards or gypsum boards, are used in a wide variety of indoor and outdoor structural applications. For example, the cement boards are used as a support surface for overlying materials such as wood siding, stucco, aluminum, brick, tile, stone aggregate and marble. Also cement and gypsum aggregates themselves are used to form interior finishes such as solid surface countertops and fireplace surrounds. Also, the cement boards are used in exterior insulating systems, commercial roof deck systems, masonry applications and exterior curtain walls. In the manufacturing of such gypsum based materials, there is needed additional time and processing steps to ensure that the gypsum-based material is fully cured.

While the gypsum-based material provides an adequate building material, it would be advantageous to provide an improved composite material that has desirable high fire retardance, enhanced abuse resistance, superior structural properties, superior impact resistance, and high water resistance properties. It would also be advantageous to provide a composite material for use as building material that does not need either any acrylic resin and/or any melamine resin in order to have the desired structural qualities. In such uses, the elimination of essentially all of the acrylic and/or melamine resins would also provide processing and manufacturing advantages since such resins often require the use of additional environmental and processing regulation.

The invention will be more readily understood from the following descriptions thereof given, by way of example, with reference to the accompanying drawings.

### SUMMARY OF THE INVENTION

In one aspect, there is provided a composite material suitable for use in many diverse building material end-use applications. Non-limiting examples of such end-use applications include alternative materials to fiber cement siding materials, oriented strand board (OSB) and other engineered wood products including as a replacement for OSB sheathing, OSB roofing materials, OSB sub-flooring materials, cement or natural stone solid surfaces, wood or steel door panels, wood or aluminum window shutters, and asphalt roofing shingles.

In a broad aspect, there is provided herein a composite material that includes: i) a substantially homogeneous matrix comprised of a gypsum material and a polymer resin material, and ii) wet-used chopped strand fibers. The wet-used chopped strand fibers are substantially filamentized (i.e., separated from adjacent fibers) within the substantially homogeneous matrix.

In one particular aspect, the composite material includes a substantially homogeneous matrix of a gypsum material and a polymer resin such as a urea-formaldehyde material, and wet-used chopped strand fibers dispersed within the substantially homogeneous matrix. The composite material has desirable high fire retardance, enhanced abuse resistance, superior structural properties, superior impact resistance, and high water resistance properties.

In another aspect, there is provided a method of forming a composite material which includes: mixing a gypsum material with a polymer resin material to form a substantially homogeneous matrix and adding a sufficient quantity of wet-used chopped strand fibers to the substantially homogeneous matrix to form the composite material.

In certain embodiments, the reinforcing fibers are wet-used chopped strand glass fibers. Wet reinforcing fibers are typically agglomerated in the form of a bale or package, of individual glass fibers. The wet-used chopped strand glass fibers are less expensive to manufacture than dry chopped fibers because dry fibers are typically dried into bundles of fibers. Also, sometimes these bundled fibers are formed and wound in separate manufacturing steps before being chopped into the desired fiber length. In contrast, the use of wet chopped strand glass fibers allows an improved composite material be manufactured, at lower costs, with fewer manufacturing steps, and with less environmental impact.

In one embodiment, there is provided a composite material comprising: i) a substantially homogeneous mixture comprising a gypsum material and a polymer resin material; ii) wet-used chopped strand fibers; and, iii) water.

In another broad aspect, there is provided a method of forming a composite material which comprises: i) mixing gypsum with a polymer resin material to form a substantially homogeneous matrix, and ii) adding a sufficient quantity of wet-used chopped strand fibers to form the composite material where the composite material contains essentially no acrylic resin and essentially no melamine resin.

The foregoing and other features and advantages will appear more fully hereinafter from a consideration of the detailed description that follows. It is to be expressly understood, however, that the drawings are for illustrative purposes and are not to be construed as defining the limits of the invention.

### DESCRIPTION OF THE FIGURE

FIG. 1 is a graph showing the hardness, as measured by the Barcol Hardness number, over time for a Comparative Material as compared to the compositions described herein as Example 1 and Example 2.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references.

The terms “reinforcement fibers” and “reinforcing fibers” may be used interchangeably herein. In addition, the terms “sizing”, “size”, “sizing composition”, and “size composition” may be interchangeably used.

In a broad aspect, there is provided herein a composite material comprising: i) a substantially homogeneous matrix comprised of a gypsum material and a polymer resin material, and ii) wet-used chopped strand fibers filamentized (i.e., substantially evenly separated and well-distributed) within the substantially homogeneous matrix. In certain embodiments, the composite material contains essentially no acrylic resin and essentially no melamine resin.

In yet another broad aspect, there is provided herein a method of forming a composite material comprising: mixing gypsum with a polymer material to form a substantially homogeneous matrix, and adding a sufficient quantity of wet-used chopped strand fibers to form the composite material.

One advantage of the composite material is the ability to use the wet-used chopped strand materials “as is” in the wet state, which keeps reinforcement costs low. It is to be noted that almost all other processes require the glass fiber to be dried before use. In contrast, the substantially homogeneous matrix disclosed herein (being water-based) is unaffected by the presence of wet fibers, which is a great benefit. The substantially homogeneous matrix disclosed herein (unlike concrete), is only mildly acidic and is very compatible with such glass fibers as the Advantex® glass. The substantially homogeneous matrix does not, in effect, dissolve the glass fibers.

The composite material includes a wet-used chopped strand material component that provided the composite with the desired reinforcement, strength, stiffness, low creep, good impact, dimensional stability, nail/screw compatibility, and bonding-to-polymer properties.

In certain embodiments, the wet-used chopped strand fibers are glass fibers that are formed by drawing molten glass into filaments through a bushing or orifice plate and applying an aqueous sizing composition containing lubricants, coupling agents, and film-forming binder resins to the filaments. The sizing composition provides protection to the fibers from interfilament abrasion and promotes compatibility between the glass fibers and the matrix in which the glass fibers are to be used. After the sizing composition is applied, the wet fibers may be gathered into one or more strands, chopped, and collected. The chopped strands may contain hundreds or thousands of individual glass fibers. The collected chopped glass strands are then packaged in their wet condition as wet chopped fiber strands.

The wet-used chopped strand reinforcing fibers that are useful in the composite material may be any type of organic or inorganic fiber. In certain embodiments, it is desired that the wet-used chopped strand fibers provide good structural qualities as well as good acoustical and thermal properties to the composite material.

Non-limiting examples of suitable reinforcing fibers that may be used in the composite material include reinforcement glass fibers, wool glass fibers, natural fibers, cellulosic fibers, metal fibers, ceramic fibers, mineral fibers, carbon fibers, graphite fibers, nanofibers, or combinations thereof. The term “natural fiber” as used herein refers to plant fibers extracted from any part of a plant, including, but not limited to, the stem, seeds, leaves, roots, or bast. In the composite material, the reinforcing fibers may have the same or different lengths, diameters, and/or denier. In one embodiment, the reinforcing fibers are glass fibers, although other fibers can be used.

The wet-used chopped strand reinforcing fibers can have any suitable length that allows for good dispersion in the composite while also providing the desired structural properties. Non-limiting examples of such lengths include approximately about 1 to about 100 mm, and in certain embodiments, of from about 1 to about 10 mm, and in still other embodiments 10 to about 50 mm.

Additionally, in certain non-limiting examples, the wet-used chopped strand reinforcing fibers may have diameters of from about 8 to about 25 microns, and, in certain embodiments, can have diameters of from about 12 to about 18 microns. The wet-used chopped strand reinforcing fibers may have varying lengths, aspect ratios and diameters relative to each other within the composite material.

The wet-used chopped strand reinforcing fibers may be present in an amount of from about 1% to about 25%, by weight, of the total composite material, and, in certain embodiments, are present in an amount of from about 2% to about 8%, by weight. Also, in certain embodiments, the wet-used chopped strand fibers have a moisture content of from about 5 to about 25%, and, in certain embodiments, can have a moisture content of from about 10 to about 20%.

When wet-used chopped strand glass fibers are used as the reinforcing fibers, the glass fiber strands may be easily opened and dispersed within the substantially homogeneous matrix. The use of the wet-used chopped strand fiber causes little generation of undesirable static electricity due to the moisture present on the glass fibers.

The use of wet-used chopped strand glass fibers as the reinforcing fibers in a composite material provides a cost advantage over using the conventional dry-laid glass materials. For example, wet-used chopped strand glass fibers are less expensive to manufacture than dry chopped fibers. That is, the dry fibers require more processing and handling steps than the wet-used chopped strand fiber. For instance, the dry-use chopped fibers are typically formed, then dried, and finally packaged. The dry-use chopped fibers must then be “re-wetted” when being dispersed into a resin for the formation of any end product. Also, since the wet-used chopped strand fibers can be used “as is” the wet-used chopped strand fibers also save manufacturing time and costs.

In a particular embodiment, the wet-used chopped strand reinforcing fibrous materials are agglomerated in the form of bundles or strands of fibers or filaments. Wet glass or wet chop reinforcing fibers are then typically packaged and shipped in the form of “boxes” of “individual” wet-used chopped strand fibers.

As such, in another embodiment, the method can include at least partially opening, or dispersing, the wet-used chopped reinforcing fibers prior to their being dispensed into the gypsum urea formaldehyde mixture.

In forming the composite material, bales of the wet-used chopped strand reinforcing fibers may be filamentized by any type of suitable opening system, such as bale opening systems, which are common in the industry. The opening system serves both to decouple the loosely clustered strands of the wet-used chopped strands and to enhance the fiber-to-fiber contact. That is, when the wet-used chopped strand fibers are filamentized (i.e., substantially evenly separated and well-distributed) within the gypsum urea formaldehyde mixture, substantially all of the wet-used chopped strand fibers are in direct contact with the substantially homogeneous matrix. In certain embodiments, the

In an alternate embodiment, the wet-used chopped strand fibrous material can be formed into an impregnable material comprised of the wet-used chopped strand fibrous materials. In such embodiments, the wet-used chopped strands are substantially uniformly impregnated with the homogeneous gypsum urea formaldehyde mixture.

In certain embodiments, the present composite provides at least the advantage that there is no need to use any condensing system to remove water from the wet-used chopped strand fibers. In other particular embodiments, a suitable condensing system can be used to remove a desired amount of the free water is removed (i.e., water that is external to the wet-used chopped strand reinforcing fibers). In such certain embodiments, some or substantially all of the water can be removed by the condensing system. It should be noted that the phrase “substantially all of the water,” as it is used herein, is meant to denote that all or nearly all of the free water is removed. The condensing system may be any drying or water removal device. Non-limiting examples include an air dryer, an oven, rollers, a suction pump, a heated drum dryer, an infrared heating source, a hot air blower, or a microwave-emitting source.

In one non-limiting example, after the wet-used chopped strand reinforcing fibers have passed through the condensing system, the fibers may be passed through another opening system, such as a bale opener as is described above, to further filamentize and separate the reinforcing fibers.

It is to be noted that during the formation of the wet-used chopped strand fibers, an aqueous sizing composition is applied to the fibers after they are drawn from the bushing. The sizing may be applied by application rollers or by spraying the sizing directly onto the fibers. Generally, the sizing composition protects the fibers from breakage during subsequent processing, helps to retard interfilament abrasion, and ensures the integrity of the strands of glass fibers, e.g., the interconnection of the glass filaments that form the strand or bundle of fibers. Thus, the wet-used chopped strand fibers have water entrapped within the strands themselves. These “wetted” wet-used chopped strand fibers that are generally packaged together and which are then “opened, or filamentized.” The presence of water between and among the individual fibers greatly improves the processability in formulating the composite material.

As the wet-used chopped strand fibers are being dispersed into the substantially homogeneous matrices, the viscosity of the “matrix/fibers” composite material being formed increases. Simultaneously, the gypsum is able to be interspersed among individual wet-used chopped strand fibers, and is able to react with the water present on the wet-used chopped strand fibers. Also occurring simultaneously is the curing of the polymer resin that is present in the matrix. The use of the wet-used chopped strand fibers (with their short length and interspersed water therebetween) allows for the hydration of the gypsum as the gypsum sets and the resin material cures. The wet-used chopped strand fibers provide a balance between ease of dispersion of the fibers within the homogeneous matrix and the greater amount of fibers that can be incorporated into the composite material.

It is to be noted, however, in certain other processes, it may be desired to remove some of the excess water that is external to (i.e., on the surface of) the exterior of the wet-used chopped glass fibers. In such instances, the external water can be removed, thereby consolidating or solidifying the sizing composition on the wet-used chopped strand fibers. In certain non-limiting examples, such excess moisture on the wet-used chopped strand fibers can be removed by using a conventional dielectric (RF) oven, a fluidized bed oven such as a Cratec® oven (available from Owens Corning), or a standard rotating tray thermal oven. In such embodiments, a portion or substantially all of the excess, or external, water can be removed by the drying oven. It should be noted that the phrase “substantially all of the water” as it is used herein is meant to denote that all or nearly all of the free water from the wet-used chopped strand fibers is removed. In certain non-limiting exemplary embodiments, greater than about 99% of the free water (that is, water that is external to the reinforcement fibers) can be removed such that the wet-used chopped strand fibers can still be formed. These formed wet-used chopped strand fibers can be then dispersed into the mixture which may contain surfactants, viscosity modifiers, or other chemical agents, and agitated to disperse the wet-used chopped strand fibers throughout the mixture. It is to be appreciated, however, in certain embodiments, that the wet-used chopped strand fibers may also be individually formed and immediately deposited in the mixture without first removing any excess water therefrom.

The sizing composition on the wet-used chopped strand glass fibers also maintains fiber integrity during the formation and processing of the wet-used chopped strand fibers prior to their addition to the substantially homogenous gypsum/polymer mixture. The sizing composition permits for a quick filamentizing of the fibers during the subsequent processing steps to form a final product, and, as a result, a fast wet out of the fibers. The selective dispersion of the wet-used chopped strand fibers may be accomplished by the choice of components in the size composition and/or the amount of size composition applied to the glass fibers. The wet-used chopped strand fibers preferably have about 0.1% sizing composition present on the exterior surfaces of the glass fibers. In contrast, bundles, rovings and the like of “dried” fibers have about 0.5% to about 2.0% sizing composition present on the fibers.

In certain embodiments, there is no need for a wetting agent in order to form the composite material described herein. The wet-used chopped strand fibers are only loosely held together by the sizing composition and the surface tension of the water on the individual fibers. When the wet-used chopped strand fibers are incorporated into the water-based substantially homogeneous matrix, the wet-used chopped strand fibers are readily filamentized and become substantially evenly dispersed within the homogeneous matrix. The high level of dispersion, or separation, of the wet-used chopped strand fibers is due, at least in part, to the presence of the high amounts of water on the surfaces of the individual fibers that make up the wet-used chopped strand fibers.

The sizing composition can include one or more silane coupling agents. Silane coupling agents enhance the adhesion of the film forming copolymer to the glass fibers and reduce the level of fuzz, or broken fiber filaments, during subsequent processing. Examples of silane coupling agents which may be used in the present size composition may be characterized by the functional groups amino, epoxy, vinyl, methacryloxy, ureido, isocyanato, and azamido. Suitable coupling agents for use in the size composition are available commercially, such as, one or more of the non-limiting examples: γ-aminopropyltriethoxysilane (A-1100® available from Momentive Performance Materials) and methacryloxypropyltriethoxysilane (A-174® available from Momentive Performance Materials). The aminosilane coupling agent can be present in the size composition in an amount of from about 5 to about 30%, by weight, of the active solids in the size composition, and even more preferably, in an amount of from about 10 to about 15%, by weight, of the active solids.

The composite material also includes a gypsum material component that absorbs water, adds strength, is also a low-cost filler, and provides fire resistance to the composite material. The gypsum material is generally defined as a hydrous calcium sulfate material and can be, for example, one or more of alpha, beta or synthetic gypsums.

The composite material also includes a polymer component that provides water resistance, strength, and readily bonds to the wet-used chopped strand fibers. It is to be understood, that in certain embodiments, the polymer can be a suitable non-styrene polymer and that in certain embodiments, the polymer comprises a urea-formaldehyde (UF) resin.

While the composite material includes the above three main components, the composite material can include one or more additives that can be used. Non-limiting examples of some of these additives include: perlite as a density reducer, additional water to manage consistency and/or to help set the gypsum, a coupling agent such as a silane to improve bonding, a filler such as sand which is a low cost filler and provides additional fire resistance, a gypsum accelerator to control the hardening rate such as aluminum sulfate, and a polymer curative, such as ammonium sulfate, which speeds the UF resin cure rate.

In certain particular embodiments, the composite material can further include at least one or more of: at least one catalyst for increasing a rate of cure of the polymer resin material, at least one catalyst for increasing hardness of the gypsum during cure, at least one additive for reducing the density of the composite material, and at least one additive for improving water resistance of the composite material.

Also, it is to be noted that the composite material formulation can be optimized, depending on the end-use applications and that such factors that can be considered include, but are not limited to: type of gypsum; type of polymer; presence of fillers, density reducers, etc.; amount of water; consistency (i.e., ratio of gypsum to water), density, cost/lb.; cost/volume; viscosity; open, or cure, time; and use of extenders such as calcium carbonate or sand. These factors can be considered in order to make the lowest cost material but with the required performance characteristics. It is also to be noted that, from an environmental stand point, the composite material has low VOC's, and the components in the composite materials are generally safe, with only a small amount of free formaldehyde present in the UF resin.

It is to be noted that, a particular embodiment, the additional water needed in the formation of the composite material can at least be partially supplied by the water that is present in the polymer resin formulation, and/or present in the wet-used chopped strand fibers.

In one particular aspect, the composite material includes a substantially homogeneous matrix of a gypsum material and a urea-formaldehyde material, and wet-used chopped strand fibers dispersed within the substantially homogeneous matrix. The composite material has desirable high fire retardance, enhanced abuse resistance, superior impact resistance, and high water resistance properties.

It has surprisingly been found, in certain embodiments, that the composite material forms an especially useful building material that does not need either any acrylic resin and/or any melamine resin in order to have the desired structural qualities. The elimination of essentially all of the acrylic and/or melamine resins also provides processing and manufacturing advantages since such resins often require the use of additional environmental and processing regulation.

It is to be understood, in certain embodiments, that the substantially homogeneous matrix can also include at least one or more catalysts such as ammonium chloride, p-toluenesulfonic acid, aluminum sulfate, ammonium phosphate, or zinc nitrate in order to improve the rate of curing of the composite material.

In another aspect, there is provided herein a method of forming a composite material that includes: mixing gypsum with a urea formaldehyde material, and adding a sufficient quantity of wet laid chopped fibers to form the composite material. In one embodiment, the method can further include attaching a facing layer to at least one exposed major surface of the composite material.

One exemplary process for forming a composite material includes

blending together a gypsum material and a urea-formaldehyde material in an aqueous medium to form a substantially homogeneous matrix,

optionally, adding at least one or more of: a catalyst for increasing the rate of cure of the urea-formaldehyde material, a catalyst for increasing the hardness of the gypsum during cure, an additive to reduce density, an additive to improve water resistance;

adding a sufficient quantity of a wet-used chopped strand reinforcing material to the mixture to form a fibrous-urea-formaldehyde system, and

allowing the fibrous-urea-formaldehyde system to substantially cure into a composite material.

It is to be noted that, in the method of making the composite material, the substantially homogeneous matrix and the wet-used chopped strand fibers are blended or mixed together such that the wet-used chopped strand fibers are substantially filamentized. The individual fibers are intermingled such that there is little parallel contact between adjacent fibers in the composite material.

It is to be noted that the composite material provides an efficient processing and manufacturing system that allows the manufacturer to be able to convert the raw components into finished products very quickly and efficiently. In certain embodiments, the manufacturing can be accomplished through the use of a continuous mixer that provides a rapid conversion of the raw components into the composite material as quickly and efficiently as possible with little handling of the components and composite material. In one embodiment, the manufacturing capabilities can include a moving mold where the components are mixed rapidly and deposited into a mold that moves along a conveyer and set-ups within a few minutes.

In another aspect, there is then provided a system where the composite material is then incorporated into a desired building material. In particular embodiments, the building material can be formed by, for example, applying at least one outer strengthening layer to at least one major surface of the building composite material.

### EXAMPLES

### Examples of Formulations to be used in Making a Composite Material

It is to be noted that the term “parts” is generally intended to mean “parts, by weight” and that such terms may be used interchangeably herein.

In one embodiment, the composite material comprises, based on parts per 100 parts, by weight, gypsum material: i) a substantially homogeneous matrix comprising about 100 parts of gypsum material and from about 60 to about 75 parts of polymer resin material; ii) from about 15 to about 25 parts wet-used chopped strand fibers; and, iii) from about 10 to about 30 parts water.

Also, in certain embodiments, the composite material can further include at least one or more of: at least one catalyst for increasing a rate of cure of the polymer material, at least one catalyst for increasing hardness of the gypsum during cure, at least one additive for reducing the density of the composite material, and at least one additive for improving water resistance of the composite material.

In one embodiment, the substantially homogeneous matrix comprises about 100 parts gypsum, and from about 68 to about 70 parts of a urea formaldehyde polymer resin material; and the composite material includes from about 18 to about 20 parts wet-used chopped strand fibers, and from about 18 to about 20 parts water.

In another embodiment, the substantially homogeneous matrix comprises about 100 parts gypsum, and from about 72 to about 75 parts urea formaldehyde polymer resin; and, the composite material includes the from about 18 to about 19 parts wet-used chopped strand fibers, and, from about 13 to about 16 parts water.

In certain embodiments, the composite material contains essentially no acrylic resin and essentially no melamine resin. Also, in certain embodiments, the chopped glass fibers at least include wet-used chopped strand glass fibers.

In certain embodiments, the composite material further includes: from about 8 to about 10 parts of a filler material, from about 0.2 to about 0.5 parts of a silane coupling agent, and from about 0.25 to about 0.5 parts of a hardener.

As can be seen in the Figure and in the Tables below, it has been found that the composite material has a better Barcol Hardness number than a commercial polymer/gypsum Comparative Material from Ball Consulting which uses alpha gypsum, acrylic latex and a solid melamine-urea formaldehyde resin. When the Comparative Material is mixed it is pourable and sets up overnight. A plastic beaker was used as a mold and the solid “puck” popped out after setup. In order to measure cure or hardness the samples were tested with a Barcol tester which measures the force associated with indenting.

TABLE 1

| Formulation | Compar. (g) | Ex. 1 (g) | Ex. 2 (g) |
|---|---|---|---|
| Gypsum (FRG 95) | 200 | 200 | 200 |
| Acrylic resin (VF-812) | 100 | | |
| Melamine resin | 20 | | |
| Urea-formaldehyde (UF) resin | | 108 | |
| (Hexion 472 ®) | | | |
| Urea-formaldehyde (UF) resin | | | 117 |
| (GP 491 ®) | | | |
| Ammonium sulfate | 1 | 1 | 1 |
| Water | 10 | 22 | 13 |

Barcol Hardness Number

| | | | |
|---|---|---|---|
| Barcol Hardness # | 0 | 0 | 0 |
| after 0 hours (0 days) | | | |
| Barcol Hardness # | 7 | 41 | 0 |
| after 68 hours (3 days) | | | |
| Barcol Hardness # | 16 | 42 | 10 |
| after 163 hours (7days) | | | |
| Barcol Hardness # | 21 | 46 | 23 |
| after 242 hours (10 days) | | | |
| Barcol Hardness # | 32 | 49 | 42 |
| after 524 hours (22 days) | | | |
| Barcol Hardness # | 36 | 49 | 45 |
| after 912 hours (38 days) | | | |

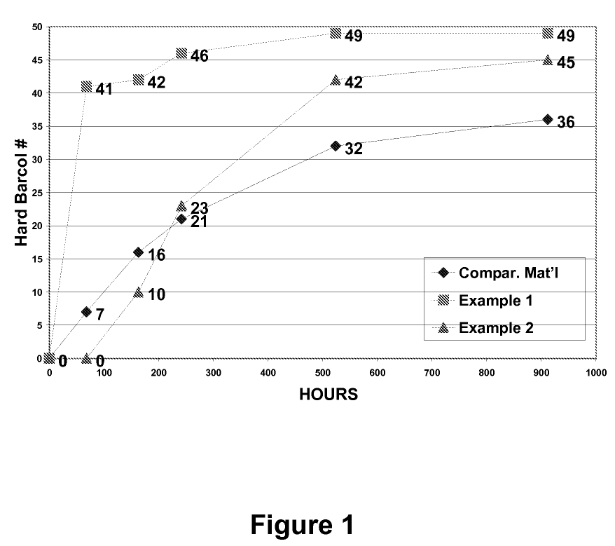

FIG. 1 shows the greatly improved Barcol Hardness test results for Example 1 and Example 2 in contrast to the Comparative Material which never reached the Barcol Hardness numbers as the Example 1 and Example 2, even after 38 days of cure time. The graph in FIG. 1 shows that the Example 1 with the Hexion 472 UF resin system cures very rapidly and the system develops hardness much more quickly than the Comparative Material or the Example 2 with the GP 491 UF resin system. The GP 491 UF resin system does eventually get hard and passes the melamine-acrylic system of the Comparative Material. The GP 491 UF resin system is thus useful in end use applications where a longer cure rate is either desired or can be tolerated. It is to be noted that both the GP 491 and Hexion 472 UF resins are much lower in cost compared to the melamine-acrylic system of the Comparative Material.

### Examples of Composite Materials

In certain embodiments, the composite material can include the gypsum, polymer and wet-used chopped strand fiber components in the ranges as set forth below in Table 2. In certain embodiments, the composite material can include one or more additives in the ranges as also set forth in Table 2 below, where the parts, by wt., are per 100 parts, by wt., gypsum:

TABLE 2

| Material | Parts, by wt. | %, by wt. |
|---|---|---|
| Urea formaldehyde resin (65%) | 60-75 | 30-35 |
| Wet-used chopped strand fibers | 15-25 | 1-25 or 8-10 |
| Gypsum | 100 | 40-50 |
| Filler | 0-10 | 0-6 |
| Coupling Agent | 0-0.5 | 0-0.3 |
| Hardener | 0-0.5 | 0-0.3 |
| Water | 15-30 | 7-10 |
| Total | | 100 |

One example of a fiber reinforced material is shown in Table 3 below, where the fiber reinforced materials were made as follows for Example 3 where the parts, by wt., are per 100 parts, by wt., gypsum.

TABLE 3

| Example 3 - Material | Wt. (g) | Parts, by wt. | %, by wt. |
|---|---|---|---|
| Urea formaldehyde resin - | 1894 | 68.4 | 31.69 |
| Hex 472 ® (65%) | | | |
| Fibers - Wet-used Chopped | 507 | 18.3 | 8.48 |
| Strand ¼″ length | | | |
| Alpha gypsum | 2769 | 100 | 46.34 |
| Filler - Sil-Cel 43-BC 0.30 ® | 252 | 9.1 | 4.22 |
| Silane - A1100 ® | 9.5 | 0.34 | 0.16 |
| Hardener - ammonium | 7.6 | 0.27 | 0.13 |
| sulfate | | | |
| Water | 537 | 19.3 | 8.99 |
| Total | 5976 | | 100 |

Another example of a fiber reinforced material is shown in Table 4 below, where the fiber reinforced materials were made as follows for Example 4 where the parts, by wt., are per 100 parts, by wt., gypsum.

TABLE 4

| Example 4 - Material | Wt. (g) | Parts, by wt. | %, by wt. |
|---|---|---|---|
| Urea formaldehyde resin - | 2018 | 72.87 | 33.77 |
| GP 414 ® (61%) | | | |
| Fibers - Wet-used Chopped | 507 | 18.3 | 8.48 |
| Strand ¼″ length | | | |
| Alpha gypsum | 2769 | 100 | 46.34 |
| Filler - Sil-Cel 43-BC 0.30 ® | 252 | 9.1 | 4.22 |
| Silane - A1100 ® | 9.5 | 0.34 | 0.16 |
| Hardener - ammonium | 7.6 | 0.27 | 0.13 |
| sulfate | | | |
| Water | 413 | 14.9 | 6.91 |
| Total | 5976 | | 100 |

### Examples of Building Materials

In another broad aspect, there is provided herein building materials that are formed using the composite materials described herein.

It is to be noted that until the present invention, the wet-used chopped strand materials have mainly been used for making roofing mats or in applications where the wet-used chopped strand materials are only present in very low levels, such as in the formation of drywall where the drywall has about 0.2% fibers.

Until now, there has not been any use of the wet-used chopped strand materials in a building material “as is.” This provides distinct advantages over many types of prior building material products where the fibers needed to be formed into a mat before being formed into the end use building material product.

In contrast, the composite material, as described herein, can be formed into a drywall material that has relatively high amounts of wet-use chopped strand materials. Also, the building material made from such composite material thus can have relatively high amounts of water which, in turn, improves the fire ratings of the building materials.

Building Panels

The building materials are suitable for use in many diverse building material end-use applications. Non-limiting examples of such end-use applications include: alternative materials to fiber cement siding materials; oriented strand board (OSB), including, for example, as a replacement for OSB sheathing; OSB roofing materials; OSB sub-flooring materials; cement or natural stone solid surfaces; wood or steel door panels; wood or aluminum window shutters; and, asphalt roofing shingles.

The building materials made with the Examples 3 and 4 formulations also showed good handling properties, a good Barcol Hardness number and a good cure rate.

In particular non-limiting embodiments, the composite can be used to make 4′×8′ sheathing products (wall or roof) and to make a thin drywall of sizes up to 8′×40′. Also, flat sheets of any thickness are possible to be made using the composite material.

Roofing Materials

In another non-limiting example, molded roofing shingles were made using a formulation of the composite material, as generally described in Table 5 below.

TABLE 5

| Material | Wt. (g) |
|---|---|
| Urea formaldehyde resin - Hex 472 ® (65%) | 710 |
| Fibers - Wet-used Chopped Strand ¼″ length | 100 |
| Alpha gypsum | 1039 |
| Filler - Sil-Cel 43-BC 0.30 ® | |
| Welling Agent - Sil-Wet L-77 ® | 0.4 |
| Hardener - ammonium sulfate | 3 |
| Water | 50 |
| Total | 1902 |

A molded composite shingle was made by using a mold having a mold cavity section in the shape of the roofing shingle and included various textures and shapes similar to an asphalt shingle having granules thereon. The mold was pretreated with a gel coat material to aid in the removal of the composite shingle from the mold. In one embodiment, the gel coat comprised about 300 g gypsum, about 150 g acrylic resin, about 10 g water, and about 0.7 g wetting agent. The gel coated was applied to the cavity of the mold and allowed to dry for about one hour. Thereafter, the composite material was poured into the mold and allowed to cure.

It is to be noted, that in certain embodiments, a top surface of the mold can be covered to allow a generally uniform curing of the shingle. In other embodiments, the composite shingle can be cured in the mold for a desired amount of time, then removed and positioned such that both sides of the shingle can cure evenly, thereby preventing any warping of the composite shingle.

The molded composite material roofing shingle has a pleasing appearance and the “granulated” surface was easily visible. In tests of a standard-sized shingle of about 13″×39″×⅛″, weight about 3.25 lbs, the molded roofing shingle had desired flexibility and did not break or shatter when nailed to a substrate.

In still other embodiments, a mold having a slate appearance or a mold having a tile appearance can be used to form a roofing material. In other non-limiting embodiments, the composite material can be used as a roofing panel in any desired size, as a real clay tile substitute, as a real slate substitute, and as a real wooden shake substitute.

In certain embodiments, the composite material can be formed into a roofing material that can be painted. The molded composite shingle has a surface that readily accepts a sealant and/or paint. The paint can be any suitable material, such as, but not limited to, a latex paint material. In this manner, a generic color shingle can be produced that allows the end use customer to paint, or repaint, the shingles.

Also, the molded roofing composite material can be coated with a suitable material, such as paint or other sealant, to improve water resistance or simply to add new life to the roof to make it last longer. It is to be noted that several advantages of a composite material roof are fire resistance, mold resistance, wind resistance and hail resistance. The composite material has a reasonable weight, does not break and is fire resistant. In contrast, clay is heavy, slate easily breaks, and shakes burn easily.

Exterior Siding Materials

In another non-limiting example, molded exterior building boards, or siding, can be made using the composite material as generally described herein. For example, boards suitable for installation on the side of a building can have a front surface suitable for exposure to the weather, a rear surface, an upper end and a lower end.

The siding building board can be formed by filling a mold with the composite material. The mold can have a mold cavity section in the shape of the siding where the mold surface provides at least the exterior surface with a desired texture and shape, such as, but not limited to wood grain, stone or other aesthetically pleasing surface. Alternatively, the building board can be formed by extruding the composite material onto a suitable substrate and forming a suitably sized and shaped board.

In one non-limiting example, exterior residential siding materials are made from the composite material which provides a siding that looks like wood, but is fire and rot resistant.

Layered Building Materials

Also provided herein are building materials at least partially comprised of the composite material described herein. Non-limiting examples of such building materials at least partially comprised of the composite material include, exterior siding materials, sheathing materials, interior surfacing panels, interior acoustic panel materials, solid surfacing systems, interior and exterior door panels, interior and exterior window shutters, roof decking materials, roofing panels, and sub-flooring materials.

The use of the composite material allows for the formation of thin building materials without compromising the structural integrity of the building material. As such, building materials that incorporate the composite material can be made that are thinner than previous types of building materials. The composite material can be incorporated into the building material without undue risk of breakage or damage.

In one example, a layered material can be made by using the composite material formulation (for example, as shown in Table 5) to form two or more individual layers that can be cured or laminated together.

In a particular embodiment, the building material can further include a facing layer on at least one exposed major surface of composite material.

It is to be understood that, in certain embodiments, the building materials can be made using an open mold process where the composite material is dispensed into a formed mold.

It is also to be understood that, in certain embodiments, the building materials can be made using an extrusion process where the composite material is dispensed or extruded onto a substrate or into a formed mold.

Complex Shaped Building Materials

It should be noted that the composite material can be formed into complex shaped building materials. Such building materials are more versatile than other types of building materials such as oriented strand board (OSB).

The building materials that incorporate the composite material can be formed into more than just boards or panels having a constant rectangular cross section. The composite material can be molded, using a suitable molding technology, into complex three-dimensional shapes. Thus, the structural integrity of the composite material allows building materials to be formed that are in curved, waved, or other three-dimensional forms.

In addition, the structural integrity of the composite material allows for thinner sections of the composite material to be incorporated into building materials without undue risk of breakage or damage. The use of less material, while achieving surprisingly advantageous structural properties, makes the complex shaped building materials especially useful and desirable.

Multi-layered Building Materials

In another broad aspect, there is provided herein a building material at least partially comprised of the composite material as described herein. In certain embodiments, the building material further includes a facing layer on at least one exposed major surface of composite material. It is within the contemplated scope of the disclosure herein that the building material can be one or more of: a siding material, a sheathing material, a roof decking material, a roofing panel, a roofing shingle, a sub-flooring material, a solid surfacing material, an interior finishing panel, an interior or exterior door panel, and an interior or exterior window shutter.

In another aspect, there is provided herein a building material that includes one or more outer strengthening layers comprised of the composite material. In certain embodiments, outer layered materials can be fed from a supply onto at least one major surface of the composite material to form a multilayered product. In a particular embodiment, the method can further comprise attaching at least one facing layer to at least one exposed major surface of the composite material.

In one particular embodiment, first and second outer layers are positioned on the opposing major surfaces of the composite material. The outer layers may be attached to the composite material in any suitable manner, including using such non-limiting methods as a nip-roll system or a laminator.

Exterior wall sheathing can be made using the composite material as described herein where the polymer/gypsum mixture can be combined in multiple layers to make sheets of wall sheathing. This product is semi-structural, fire resistant, readily “nailable” and “screwable”. Any thickness of sheathing can be made simply by adding layers of composite materials.

Exterior roof sheathing can also be made using the composite material as described herein using the same method as described above. The roof sheathing has good rot resistance, water resistance and fire resistance.

Thin drywall can be made using the composite material as described herein where the thin drywall is a one piece wall. The thin drywall is especially useful in the manufactured home market or for commercial walls and ceiling applications. In certain embodiments, the thin composite material drywall can be made in 0.125″ thickness (three layers) which can then be glued up as one piece on each wall of the manufactured home or used in commercial applications. Also, a manufacturing process can be used to make sheets as big as 8 ft wide by 40 ft long.

In another embodiment, the composite material can be made into a continuous, composite panel. The composite material provides commercial installers with an improved product that has reduced joints and less “mudding” to finish. Also, the thin section composite materials allow for easy curves/bending which is also very desirable and useful for commercial applications.

While the compositions and methods of this invention have been described in terms of the foregoing illustrative embodiments, it will be apparent to those skilled in the art that variations, changes, modifications, and alterations may be applied to the compositions and/or methods described herein, without departing from the true concept, spirit, and scope of the invention.

The above descriptions of the preferred and alternative embodiments of the present invention are intended to be illustrative and are not intended to be limiting upon the scope and content of the following claims.

1. A composite material comprising: i) a substantially homogeneous matrix comprised of one of an alpha gypsum material and a beta gypsum material and a polymer resin material consisting essentially of a urea formaldehyde resin and, and ii) wet-used chopped strand fibers, wherein the wet-used chopped strand fibers are substantially filamentized within the substantially homogeneous matrix.

2. The composite material of claim 1, comprising, based on parts per 100 parts, by weight, gypsum material:
i) about 100 parts of gypsum material;
ii) 60 to about 75 parts of polymer resin material;
iii) about 15 to about 25 parts wet-used chopped strand fibers; and,
iv) about 10 to about 30 parts water.

3. (canceled)

4. The composite material of claim 1, wherein the wet-used chopped strand fibers comprise fiberglass fibers.

5. The composite material of claim 1, wherein the wet-used chopped strand fibers comprise glass fibers having about 0.1% of a sizing composition on exterior surfaces of the glass fibers.

6. The composite material of claim 1, wherein the wet-used chopped strand fibers have lengths that ranges between about ¼ inch to about 2 inches.

7. (canceled)

8. The composite material of claim 1, wherein the composite material contains essentially no acrylic resin and essentially no melamine resin.

9. The composite material of claim 1, further including at least one or more of: at least one catalyst for increasing a rate of cure of the polymer material, at least one catalyst for increasing hardness of the gypsum during cure, at least one additive for reducing the density of the composite material, and at least one additive for improving water resistance of the composite material.

10. A method of forming a composite material comprising:
mixing gypsum with a polymer material to form a substantially homogeneous matrix,
adding a sufficient quantity of wet-used chopped strand fibers to the substantially homogeneous matrix, and
blending the substantially homogeneous matrix and the wet-used chopped strand fibers whereby the wet-used chopped strand fibers are substantially filamentized within the substantially homogeneous matrix,
wherein the gypsum is one of an alpha gypsum material and a beta gypsum material;
wherein the polymer resin material consists essentially of a urea formaldehyde resin; and
wherein the resulting composite material comprises, based on parts per 100 parts, by weight, gypsum material:
about 100 parts of a gypsum material,
about 60 to about 75 parts of polymer resin material,
about 15 to about 25 parts wet-used chopped strand fibers, and
about 12 to about 30 parts water.

11. The method of claim 10, wherein the composite material contains essentially no acrylic resin and essentially no melamine resin.

12. The method of claim 10, wherein the wet-used chopped strand fibers comprise glass fibers.

13. The method of claim 10, further comprising attaching at least one facing layer to at least one exposed major surface of the composite material.

14. A building material at least partially comprised of a composite material comprising a substantially homogeneous matrix of a gypsum material and a polymer resin material, and wet-used chopped strand fibers filamentized within the substantially homogeneous matrix;
wherein the gypsum is one of an alpha gypsum material and a beta gypsum material, and wherein the polymer resin material consists essentially of a urea formaldehyde resin.

15. The building material of claim 14, wherein the building material further includes a facing layer on at least one exposed major surface of the composite material.

16. The building material of claim 14, wherein the building material is one or more of: a siding material, a sheathing material, a roof decking material, a roofing panel, a roofing shingle, a sub-flooring material, a solid surfacing material, an interior finishing panel, an interior or exterior door panel, and an interior or exterior window shutter.

17. The building material of claim 14, wherein the composite material comprising, based on parts per 100 parts, by weight, gypsum material:
i) about 100 parts of a gypsum material;
ii) about 60 to about 75 parts of a polymer resin material;
iii) about 15 to about 25 parts wet-used chopped strand fibers; and,
iv) about 12 to about 30 parts, by weight, water.

18. The building material of claim 17, wherein the wet-used chopped strand fibers comprise glass fibers.

19. The building material of claim 17, wherein the building material is one or more of: an exterior building board, a sheathing material, a roof decking material, a roofing panel, a molded roofing shingle, a sub-flooring material, a solid surfacing material, an interior finishing panel, an interior or exterior door panel, and an interior or exterior window shutter.

20. The building material of claim 1, wherein the building material is an exterior building board.

21. The composite material of claim 1, wherein the urea formaldehyde resin is Hexion 472.

22. The composite material of claim 1, wherein the substantially homogeneous matrix is mildly acidic.
